(19) United States
(12) Patent Application Publication
(10) Pub. No.: US 2014/0368374 A1
(43) Pub. Date: Dec. 18, 2014

(54) RADAR APPARATUS AND ANTENNA APPARATUS

(71) Applicant: MANDO CORPORATION, Pyeongtaek-Si (KR)

(72) Inventors: Seung Un CHOI, Suwon-si (KR); Seong Hee JEONG, Yongin-si (KR)

(21) Appl. No.: 14/303,107

(22) Filed: Jun. 12, 2014

(30) Foreign Application Priority Data
Jun. 12, 2013 (KR) 10-2013-0066873

(51) Int. Cl. G01S 7/02; G01S 13/04

(52) U.S. Cl. CPC G01S 7/02; G01S 13/04
USPC 342/27; 342/175

(57) ABSTRACT

Disclosed are a radar apparatus and an antenna apparatus. In particular, disclosed are a radar apparatus and an antenna apparatus including an antenna structure capable of suppressing a grating lobe while enhancing resolution.

### CROSS-REFERENCE TO RELATED APPLICATION

This application claims priority from and the benefit under 35 U.S.C. §119(a) of Korean Patent Application No. 10-2013-0066873, filed on Jun. 12, 2013, which is hereby incorporated by reference for all purposes as if fully set forth herein.

### BACKGROUND OF THE INVENTION

1. Field of the Invention

The present invention relates to a radar apparatus and an antenna apparatus.

2. Description of the Prior Art

A radar apparatus in the related art uses an antenna structure that increases an antenna interval on a reception end so as to enhance accuracy of sensing an object, i.e. resolution.

However, although such an antenna structure may enhance resolution, there is a problem in that a grating lobe occurrence position is close to a main beam position, i.e. the center position due to the increased antenna interval on the reception end.

In addition, the radar apparatus in the related art has a problem in that an object sensing performance is poor since a lot of signals are received on an inclined area other than an interested front area.

### SUMMARY OF THE INVENTION

In this background, an object of the present invention is to provide a radar apparatus and an antenna apparatus which are provided with an antenna structure capable of suppressing grating lobe while enhancing resolution.

Another object of the present invention is to provide a radar apparatus and an antenna apparatus which are provided with an antenna grouping structure which is designed by arranging transmission antennas having a smaller beam width and tying a plurality of transmission antennas together so as to reduce signal reception in an inclined area other than an interested front area.

In order to achieve the above-mentioned objects, according to an aspect of the present invention, there is provided a radar apparatus including: a transmission antenna unit including a plurality of transmission antennas; a transmission antenna grouping unit configured to group the plurality of transmission antennas by a predetermined number of transmission antenna groups such that the transmission antenna groups by the predetermined number of transmission antenna groups are arranged and formed at a predetermined transmission antenna group interval; a reception antenna unit including a plurality of reception antennas arranged at a reception antenna interval which is determined based on the number of transmission antenna groups and the transmission antenna group interval; a signal transmission/reception unit configured to transmit a signal through the transmission antenna groups by the number of the transmission antenna groups and receive a signal when the transmitted signal is reflected through the plurality of reception antennas; and an object sensing unit configured to sense an object based on the received signal.

According to another aspect of the present invention, there is provided an antenna apparatus including: a transmission antenna unit including a plurality of transmission antennas; a transmission antenna grouping unit configured to group the plurality of transmission antennas by a predetermined number of transmission antenna groups such that the transmission antenna groups by the predetermined number of transmission antenna groups are arranged and formed at a predetermined transmission antenna group interval; and a reception antenna unit including a plurality of reception antennas arranged at a reception antenna interval which is determined based on the number of transmission antenna groups and the transmission antenna group interval.

According to the present invention described above, it is possible to provide a radar apparatus and an antenna apparatus which are provided with an antenna structure capable of suppressing a grating lobe while enhancing resolution.

In addition, according to the present invention, it is possible to provide a radar apparatus and an antenna apparatus which are provided with an antenna grouping structure which is designed by arranging transmission antennas having a smaller beam width and tying a plurality of transmission antennas together so as to reduce signal reception in an inclined area other than an interested front area.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a radar apparatus according to an exemplary embodiment of the present invention;

FIG. 2 is a view schematically illustrating an entire antenna structure of a radar apparatus according to an exemplary embodiment of the present invention;

FIGS. 3a and 3b are views exemplifying a transmission antenna structure of a radar apparatus according to an exemplary embodiment of the present invention;

FIGS. 4 and 5 are views exemplifying entire antenna structures to which a method of forming virtual reception antennas is applied in a radar apparatus according to an exemplary embodiment of the present invention;

FIG. 6 is a block diagram of an antenna apparatus according to an exemplary embodiment of the present invention;

FIG. 7 is a view for describing a principle of avoiding a grating lobe phenomenon in a radar apparatus and an antenna apparatus according to an exemplary embodiment of the present invention.

### DETAILED DESCRIPTION OF THE EXEMPLARY EMBODIMENTS

The present invention relates a radar apparatus and an antenna apparatus which are provided with an antenna structure capable of suppressing a grating lobe while enhancing resolution (also referred to as “resolving power or discrimination”).

An antenna structure exemplarily disclosed herein has an antenna arrangement structure with an expanded aperture so as to enhance resolution and suppress a grating lob, and may further include an antenna arrangement structure in which virtual reception antennas are formed and the forming positions thereof are controlled.

In addition, an antenna structure exemplarily disclosed herein may further include an antenna grouping structure which is designed by arranging transmission antennas having a smaller beam width and tying a plurality of transmission antennas together so as to reduce signal reception in an inclined area other than an interested front area.

Hereinafter, the antenna structures disclosed herein and a radar apparatus and an antenna apparatus using the same will be described in more detail with reference to illustrative drawings.

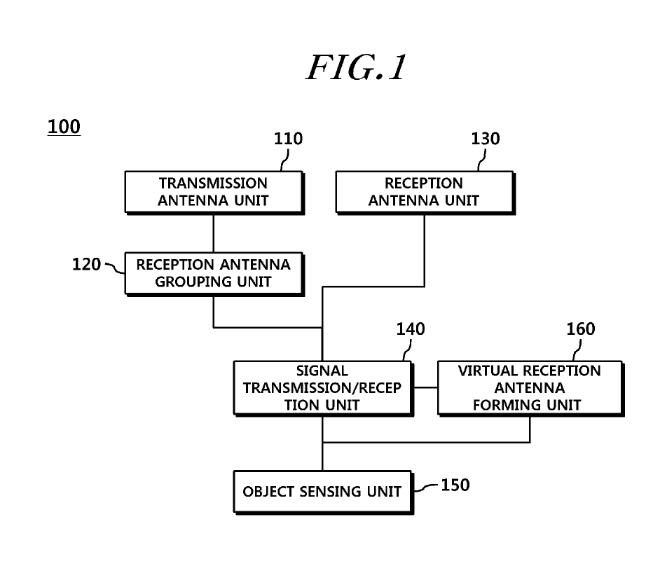

FIG. 1 is a block diagram of a radar apparatus 100 according to an exemplary embodiment of the present invention.

Referring to FIG. 1, the radar apparatus 100 according to an exemplary embodiment of the present invention includes a transmission antenna unit 110, a transmission antenna grouping unit 120, a reception antenna unit 130, a signal transmission/reception unit 140, and an object sensing unit 150.

The transmission antenna unit 110 includes a plurality of transmission antenna for signal transmission.

The transmission antenna grouping unit 120 groups a plurality of transmission antennas by a predetermined number of transmission antenna groups such that the transmission antenna groups are formed by the predetermined number of transmission antenna groups and spaced apart from each other at a predetermined transmission antenna group interval.

The reception antenna unit 130 includes a plurality of reception antennas which are arranged to be spaced apart from each by a reception antenna interval. Here, the reception antenna space may be defined by the number of transmission antenna groups and a transmission antenna group interval. The reception antenna interval, the number of transmission antenna groups, and the transmission antenna group interval may be defined by a relation function (e.g., a reception antenna interval=the number of transmission antenna groups×a transmission antenna group interval). That is, two values among the reception antenna interval, the number of transmission antenna groups and the transmission antenna group interval may be defined in advance and the remaining one value may be defined depending on the two pre-defined values.

The signal transmission/reception unit 130 may transmit signals through the transmission antenna groups by the number of transmission antenna groups and receive signals when the transmitted signals are reflected around the radar apparatus 100 through a plurality of reception antennas.

The object sensing unit 150 may sense an object based on the received signals.

Each of the components briefly described above will be described in more detail below.

The above described transmission antenna unit 110 and reception antenna unit 120 may be components included in a single antenna unit.

The above-described transmission antenna unit 110 may include Nt (≧2) transmission antennas, the reception antenna unit 130 may include Nr (≧2) reception antennas, in which the Nt transmission antennas and the Nr reception antenna may have a specific structure (interval, number, arranged position, grouping, etc.) in consideration of resolution, grating lobe, etc. Here, Nt refers to the total number of transmission antennas, and Nr refers to the number of real reception antennas. The resolution herein is also referred to as resolution power and means a performance of correctly discriminating two adjacent objects. This is one of very important performance factors of the radar apparatus 100.

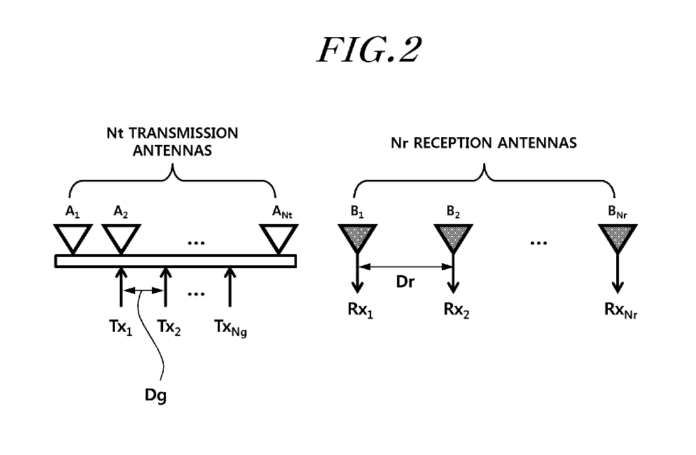

Referring to FIG. 2, the transmission antenna grouping unit 120 groups Nt transmission antennas A₁, A₂ . . . . , A_{Nt} such that transmission antenna groups G₁, G₂, . . . , G_{Ng} may be formed by a predetermined number Ng of transmission antenna groups.

A signal is transmitted from each of the transmission antenna groups formed by such transmission antenna grouping. That is, a Tx₁ signal is transmitted from a transmission antenna group G₁, a Tx₂ signal is transmitted from a transmission antenna group G₂, . . . , and a Tx_{Ng} signal is transmitted from a transmission antenna group G_{Ng}.

It may be considered that the respective transmission antenna groups are spaced apart from a predetermined interval (transmission antenna group interval). That is, it may be considered that radar apparatus 100 transmits signals to be spaced from each other by a predetermined interval (transmission antenna group interval).

Referring to FIG. 2 and Table 1 below, a transmission antenna structure through the transmission antenna grouping of Nt transmission antennas A₁, A₂, . . . , A_{Nt} may be defined by the total number of transmission antennas Nt, the size of a transmission antenna group n, the number of the transmission antenna groups Ng and the interval of the transmission antenna groups Dg, and a reception antenna structure for Nr reception antennas B₁, B₂, . . . , B_{N}, may be defined by the number of the reception antennas Nr and the interval of the reception antennas Dr.

TABLE 1

| | | |
|---|---|---|
| Transmission | Nt | Total Number of Transmission Antennas |
| Antenna | n | Size of Transmission Antenna Group |
| Structure | Ng | Number of Transmission Antenna Groups |
| | Dg | Interval of Transmission Antenna Groups |
| Reception | Nr | Number of Reception Antennas |
| Antenna | Dr | Interval of Reception Antennas |
| Structure | | |

Some of the six information items (Nt, n Ng, Dg, Nr, Dr) in Table 1 are predetermined design values, and the remainder may be determined according to a relation function depending on the predetermined design values. For example, the number of transmission antenna groups Ng, the interval of transmission antenna groups Dg, and the number of reception antennas Nr may be design values predetermined depending on requirement conditions of the radar apparatus 100 (e.g., a resolution condition, a grating lobe avoidance condition, a beam pattern condition, etc.). In addition, the number of transmission antenna groups Ng may be an information item determined based on the total number of transmission antennas Nt and the number of transmission antenna groups n. Here, the size of a transmission antenna group n is the number of transmission antennas in the transmission antenna group.

The interval of reception antennas Dr, the number of transmission antenna groups Ng, and the interval of transmission antenna groups Dg may have a relationship of Equation 1 as follows.

Dr=Ng×Dg Equation 1

According to Equation 1, the interval of reception antennas Dr may be a value obtained by multiplying the number of transmission antenna groups Ng and the interval of transmission antenna groups Dg.

Since the interval of reception antenna Dr is determined as described above, the radar apparatus 100 according to the exemplary embodiment of the present invention may increase an object detection accuracy in performing an object detection function of detecting a distance to an object, a velocity of the object, and a bearing of the object using reception signals received through the plurality of reception antennas. That is, high resolution may be implemented. The antenna structure that increases the interval of reception antennas for implementing the high resolution as described above may be referred to as an “expanded aperture structure”.

Meanwhile, when the antenna structure of the expanded aperture structure is provided, a grating lobe occurrence position on the reception end approaches to the center position where a main beam is positioned. Accordingly, the radar apparatus 100 according to the exemplary embodiment of the present invention may further include an antenna structure having a “virtual aperture structure” through the formation of virtual reception antennas so as to make the grating lobe occurrence position distant from the center position where the main beam is positioned, that is, to suppress the grating lobe. Such a virtual aperture structure will be described again below.

The above-described transmission antenna grouping unit 120 may be implemented by, for example, a circuit configured to interconnect transmission antennas.

The transmission antenna grouping of the transmission antenna grouping unit 120 will be described in more detail below.

The transmission antenna grouping unit 120 may perform transmission antenna grouping such that the transmission antennas included in each of the transmission antenna groups may overlap. That is, the transmission antenna grouping unit 120 may cause at least one of the plurality of transmission antennas to be commonly included in two or more transmission antenna groups.

Each of the transmission antenna groups formed by the transmission antenna grouping by the above-described transmission antenna grouping unit 120 may be a transmission antenna group in which the transmission antennas are tied by the same number.

The number of respective transmission antenna groups formed by the transmission antenna grouping by the above-described transmission antenna grouping unit 120 may be determined depending on the total number of transmission antennas and the size of a transmission antenna group (the number of transmission antennas in the transmission antenna group).

For example, assuming that the numbers of transmission antennas tied in the transmission antenna groups are equal to each other, the number of transmission antenna groups may be equal to a value determined by subtracting a value obtained by taking 1 from the number of transmission antennas in each transmission antenna group from the total number of transmission antennas. Consequently, the number of transmission groups, the total number of transmission antennas, and the number of transmission antennas in each transmission antenna group, may have a relationship of Equation 2 as follows.

Ng=Nt−n+1 Equation 2

In Equation 2, Ng is the number of transmission antenna groups, Nt is the total number of transmission antennas, and n is the size of a transmission antenna group (the number of transmission antennas in the transmission antenna group).

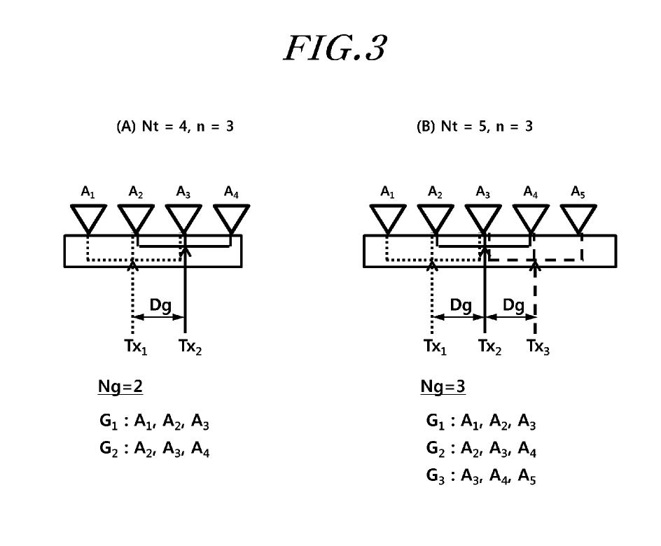

The above-described transmission antenna grouping and the number of transmission antenna groups thereby will be described with reference to FIGS. 3a and 3b by way of an example.

FIGS. 3a and 3b are views exemplifying a transmission antenna structure of a radar apparatus 100 according to an exemplary embodiment of the present invention.

FIG. 3a is a view illustrating transmission antenna grouping in a case where the total number of transmission antennas is four, and the size of each transmission antenna group (the number of transmission antenna in the transmission antenna group) is three. In addition, FIG. 3b is a view illustrating transmission antenna grouping in a case where the total number of transmission antennas is five, and the size of each transmission antenna group is three.

Referring to FIG. 3a, according to the grouping of four transmission antennas A₁, A₂, A₃, and A₄, two transmission antenna groups G₁ and G₂ are formed.

Referring to FIG. 3a, the transmission antenna group G₁ is a group in which the transmission antenna A₁, the transmission antenna A₂, and the transmission antenna A₃ are tied together and transmits a Tx₁ signal. The transmission antenna group G₂ is a group in which the transmission antenna A₂, the transmission antenna A₃, and the transmission antenna A₄ are tied together and transmits a Tx₂ signal.

Referring to FIG. 3b, according to the grouping of five transmission antennas A₁, A₂, A₃, A₄, and A₅, three transmission antenna groups G₁, G₂, and G₃ are formed.

Referring to FIG. 3b, the transmission antenna group G₁ is a group in which the transmission antenna A₁, the transmission antenna A₂, and the transmission antenna A₃ are tied together, and transmits the Tx₁ signal. The transmission antenna group G₂ is a group in which the transmission antenna A₂, transmission antenna A₃, and transmission antenna A₄ are tied together and transmits the Tx₂ signal. The transmission antenna group G₃ is a group in which the transmission antenna A₃, the transmission antenna A₄, and the transmission antenna A₅ and transmits a Tx₃ signal.

Meanwhile, as illustrated in FIG. 1, the radar apparatus 100 according to the exemplary embodiment of the present invention may further include a virtual reception antenna forming unit 160 performs a control such that virtual reception antennas are virtually formed at positions where the Nr (≧2) real reception antennas are not placed.

The above-described virtual reception antenna forming unit 160 may determine the position where the virtual reception antennas will be virtually formed based on the positions where the reception antennas are placed and the transmission antenna group interval Dg. For example, the virtual reception antennas may be virtually formed at the positions which are shifted by the transmission antenna group interval Dg from the positions where the reception antennas are placed.

The above-described virtual reception antenna forming units 160 may perform a control such that virtual reception antennas may be virtually formed at the positions where the plurality of reception antennas are not placed by performing signal processing which generates virtual signals having a phase difference which may be determined depending on the transmission antenna group interval with reference to a signal received through the plurality of reception antennas. As a result, it is possible to obtain an effect which is the same as that obtained when a real signal is received at a desired position.

That is, the virtual reception antenna forming unit 160 performs signal processing that generates a virtual signal (a signal which generates a phase difference with reference to an actually received signal) as if the signal is received through a virtual reception antenna virtually placed at a position where no real reception antenna is placed.

Herein, the description, “a virtual reception antenna is formed” may be read as “a reception signal which is not actually received is virtually generated. In this context, a virtual reception antenna arrangement structure (the interval and the number of antennas) may have the same meaning as a structure (the interval and the number of antennas) that generates a reception signal which is not actually received.

The above-described virtual reception antenna forming unit 160 may perform a control such that a same number of virtual reception antennas may be virtually formed in a space between every two adjacent reception antennas.

In addition, the above-described virtual reception antenna forming units 160 may perform a control such that virtual reception antennas may be formed by the number of virtual reception antennas which is determined depending on the number of transmission antenna groups Ng and the number of reception antennas Nr.

That is, the number of virtual reception antennas Nv may be determined by multiplying a number obtained by taking 1 from the number of transmission antenna groups Ng and the number of reception antennas Nr as expressed by Equation 3 as follows.

Nv=Nr(Ng−1) Equation 3

Meanwhile, in order to reduce the size of the radar apparatus 100 (antenna unit), the virtual reception antenna forming unit 160 may perform a control such that the virtual reception antennas are formed only inside the outermost reception antenna among the plurality of real reception antennas. That is, the virtual reception antenna forming unit 160 may not generate a virtual signal in the outside of the outermost reception antenna among the plurality of reception antennas.

When a control is performed such that no virtual reception antenna is virtually formed outside the outermost reception antenna as described above, the number of virtual reception antennas Nv to be used for sensing an object may be determined according to Equation 4 as follows.

Nv=(Nr−1)(Ng−1) Equation 4

As described above, when virtual reception antennas are formed on the reception end, the object sensing unit 150 may sense an object based on the signals actually received through Nr real reception antennas and virtual signals considered as being received through Nv virtual reception antennas (i.e., virtually generated virtual signals).

The above-described object sensing units 150 may detect, through a signal processing method, a distance to an object, a velocity of the object and a bearing of the object based on a single synthesized signal obtained by compensating for an inter-signal phase difference with respect to actually received signals and virtually generated signals and synthesizing the signals which are subjected to the phase difference compensation. When the object is detected by compensating for the inter-signal phase difference through a signal processing method as described above, it is possible to obtain an effect of correcting a misalignment for the radar apparatus 100. That is, in view of a horizontal or vertical direction, the misalignment, which causes the radar apparatus 100 transmit (irradiate) a signal in a incorrect direction, may be corrected through the signal processing method, even without physically correcting an installation angle or the like of the radar apparatus 100.

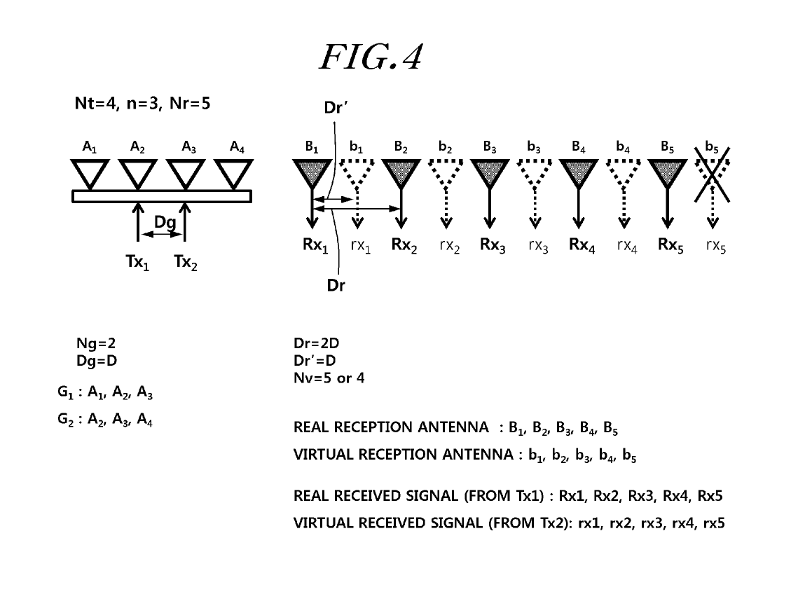

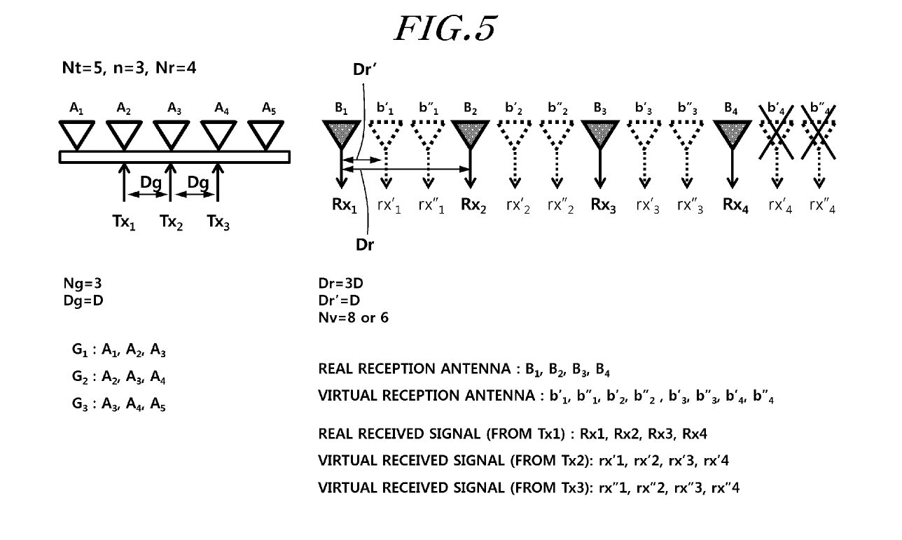

FIGS. 4 and 5 are views exemplifying entire antenna structures to which a method of forming virtual reception antennas in the radar apparatus 100 according to the exemplary embodiment of the present invention.

FIG. 4 is a view illustrating an antenna structure in which the total number of transmission antennas Nt is four and the number of reception antennas Nr is five.

In the entire antenna structure exemplified in FIG. 4, the transmission antenna structure is a structure in which there are four transmission antennas A₁, A₂, A₃, and A₄ and grouping has been performed for the four transmission antennas A₁, A₂, A₃, and A₄.

In connection with the transmission antenna grouping, the transmission antenna structure has a structure in which the size of a transmission antenna group is three and, thus, two transmission antenna groups G₁ and G₂ are formed. That is, according to the grouping of the four transmission antenna A₁, A₂, A₃, and A₄, a transmission antenna group G₁, in which the transmission antenna A₁, the transmission antenna A₂, and the transmission antenna A₃ are tied together, and a transmission antenna group G₂, in which the transmission antenna A₂, the transmission antenna A₃, and the transmission antenna A₄ are tied together, are formed.

In addition, the transmission antenna group interval Dg between the transmission antenna groups has a value D. Since each transmission antenna group is a group in which three transmission antennas are tied together, the group position of each transmission antenna group is the same as the position of the centrally positioned transmission antenna among the three transmission antennas of the transmission antenna group. According to the example FIG. 4, the group position of the transmission antenna group G₁ corresponds to the position where the transmission antenna A₂ is placed, and the group position of the transmission antenna group G₂ corresponds to the position where the transmission antenna A₃ is placed. Accordingly, the interval Dg between the transmission antenna group G₁ and the transmission antenna group G₂ may be the same as the interval d between the transmission antenna A₂₁ and the transmission antenna A₂.

In the entire antenna structure exemplified in FIG. 4, the reception antenna has a structure in which there are five reception antennas B₁, B₂, B₃, B₄, and B₅, and virtual reception antennas are virtually formed.

Referring to FIG. 4, the reception antenna interval Dr may have a value obtained by multiplying the number of transmission antenna groups Ng and the transmission antenna group interval Dg. That is, Dr=Ng×Dg=2D.

Referring to FIG. 4, according to a method of forming virtual reception antennas, five virtual reception antenna b₁, b₂, b₃, b₄, and b₅ are virtually formed at the positions where the five reception antennas B₁, B₂, B₃, B₄, and B₅ are not placed.

The number of virtual reception antennas Nv may be determined by multiplying a value obtained by taking 1 from the number of transmission antenna groups Ng and the number of reception antennas Nr. That is, Nv=Nr×(Ng−1)=5×(2−1)=5.

The positions where the virtual reception antennas are formed are determined according to the positions where the reception antennas are placed and the transmission antenna group interval Dg. That is, the virtual reception antenna b₁ is virtually formed at the position spaced apart from the position where the reception antenna B₁ is placed by the transmission antenna group interval Dg (=D), the virtual reception antenna b₂ is virtually formed at the position spaced apart from the position where the reception antenna B₂ is placed by the transmission antenna group interval Dg (=D), the virtual reception antenna b₃ is virtually formed at a position spaced apart from the position where the reception antenna B₃ is placed by the transmission antenna group interval Dg (=D), the virtual reception antenna b₄ is virtually formed at the position spaced apart from the position where the reception antenna B₄ is placed by the transmission antenna group interval Dg (=D), and the virtual reception antenna b₅ is virtually formed at the position spaced apart from the position where the reception antenna B₅ is placed by the transmission antenna group interval Dg (=D).

Considering the forming of the virtual reception antennas, the interval between every two adjacent antennas Dr′ on the reception end equals D.

Signal reception and transmission according to the entire antenna structure of FIG. 4 are as follows.

A Tx₁ signal is transmitted through the transmission antenna group G₁, and a Tx₂ signal is transmitted through the transmission antenna group G₂.

The five real reception antennas B₁, B₂, B₃, B₄, and B₅ actually receive Rx₁, Rx₂, Rx₃, Rx₄, and Rx₅ signas, respectively.

It may be considered that the five virtual reception antennas b₁, b₂, b₃, b₄, and b₅ which are formed virtually, respectively receive rx₁, rx₂, rx₃, rx₄, and rx₅ signals which are the virtual signals virtually generated by a signal processing method with reference to the actually received signals.

The signals (Rx₁ signal, Rx₂ signal, Rx₃ signal, Rx₄ signal, and Rx₅ signal) actually received through five real reception antennas B₁, B₂, B₃, B₄, and B₅ are signals received when the Tx₁ signal is reflected, and the virtual signals (rx₁ signal, rx₂ signal, rx₃ signal, rx₄ signal, and rx₅ signal) which may be considered as being virtually received through the five virtual reception antennas b₁, b₂, b₃, b₄, and b₅ which are virtually formed are virtual signals which may be considered as being received when the Tx₂ signal is reflected.

Meanwhile, referring to FIG. 4, a virtual reception antenna (b₅ in FIG. 4) may not be virtually formed outside the outermost reception antenna B₁ or B₅ among the five real reception antennas B₁, B₂, B₃, B₄, and B₅ or a corresponding signal (rx₅ in FIG. 4) may not be used even if the virtual reception antenna is virtually formed in consideration of a calculated amount or the like.

The entire antenna structure exemplified in FIG. 4 may be summarized using related factors as Table 2.

TABLE 2

| | | |
|---|---|---|
| Transmission | Nt (Total Number of Transmission | 4 |
| Antenna | Antennas) | |
| Structure | n (Size of Transmission Antenna | 3 |
| | Group) | |
| | Ng (Number of Transmission Antenna | 2 |
| | Groups) | |
| | Dg (Transmission Antenna Group | D |
| | Interval) | |
| Reception | Nr (Total Number of Reception | 5 |
| Antenna | Antennas) | |
| Structure | Dr (Reception Antenna Interval) | 2D |
| | Nv (Number of Virtual Reception | 5 or 4 |
| | Antennas) | |
| | Dr′ (Reception End Antenna | D |
| | Interval) | |

FIG. 5 is a view illustrating an antenna structure in which the total number of transmission antennas Nt is five and the number of reception antennas Nr is four.

In the entire antenna structure exemplified in FIG. 5, the transmission antenna structure has a structure in which there are five transmission antennas A₁, A₂, A₃, A₄, and A₅ and grouping for the five transmission antennas A₁, A₂, A₃, A₄, and A₅ are performed.

In connection with the transmission antenna grouping, the transmission antenna structure has a structure in which the size of a transmission antenna group n is three, and, thus, three transmission antenna groups G₁, G₂, and G₃ are formed. That is, according to the grouping of five transmission antennas A₁, A₂, A₃, A₄, and A₅, the transmission antenna group G₁ in which the transmission antenna A₁, the transmission antenna A₂, and the transmission antenna A₃ are tied together, the transmission antenna group G₂ in which the transmission antenna A₂, the transmission antenna A₃, and the transmission antenna A₄ are tied together, and the transmission antenna group G₃ in which the transmission antenna A₃, transmission antenna A₄, and transmission antenna A₅ are tied together.

In addition, the transmission antenna group interval Dg between every adjacent two transmission antenna groups has a value D. Since each of the transmission antenna groups is a group in which three transmission antennas are tied together, the group position of each transmission antenna group corresponds to the position of the transmission antenna placed at the center among the three transmission antennas. According to the example of FIG. 5, the group position of the transmission antenna group G₁ corresponds to the position where the transmission antenna A₂ is placed, the group position of the transmission antenna group G₂ corresponds to the position where the transmission antenna A₃ is placed, and the group position of the transmission antenna group G₃ corresponds to a position where the transmission antenna A₄ is placed. Accordingly, the interval Dg between the transmission antenna group G₁ and the transmission antenna group G₂ corresponds to the interval d between the transmission antenna A₂₁ and the transmission antenna A₂.

In the entire antenna structure exemplified in FIG. 5, the reception antenna structure is a structure in which there are four reception antennas B₁, B₂, B₃, and B₄ and virtual reception antennas are virtually formed.

Referring to FIG. 5, the reception antenna interval Dr may correspond to a value obtained by multiplying the number of transmission antenna groups Ng and the transmission antenna group interval Dg. That is, Dr=Ng×Dg=3D.

Referring to FIG. 5, according to the method of forming virtual reception antennas, eight virtual reception antennas b′₁, b″₁, b′₂, b″₂, b′₃, b″₃, b′₄, and b″₄ are virtually formed at the positions where four reception antennas B₁, B₂, B₃, and B₄ are not placed.

The number of virtual reception antennas Nv may be determined by multiplying a value obtained by taking 1 from the number of transmission antenna groups Ng and the number of reception antennas Nr. That is, Nv=Nr×(Ng−1)=4×(3−1)=8.

The positions where the virtual reception antennas are formed are determined according to the positions where the reception antennas are placed and the transmission antenna group interval Dg.

In other words, the virtual reception antenna b′₁ is virtually formed at the position spaced apart from the position where the reception antenna B₁ is placed by the transmission antenna group interval Dg (=D), and the virtual reception antenna b″₁ is formed at the position spaced apart from the position where the virtual reception antenna b′₁ is formed by the transmission antenna group interval Dg (=D). The virtual reception antenna b′₂ is virtually formed at the position spaced apart from the position where the reception antenna B₂ is placed by the transmission antenna group interval Dg (=D), and the virtual reception antenna b″₂ is virtually formed at the position spaced apart from the position where the virtual reception antenna b′₂ is formed by the transmission antenna group interval Dg (=D). The virtual reception antenna b′₃ is virtually formed at the position spaced apart from the position where the reception antenna B₃ is placed by the transmission antenna group interval Dg (=D), and the virtual reception antenna b″₃ is virtually formed at the position spaced apart from the position where the virtual reception antenna b′₃ is formed by the transmission antenna group interval Dg (=D). The virtual reception antenna b′₄ is virtually formed at the position spaced apart from the position where the reception antenna B₄ is placed by the transmission antenna group interval Dg (=D), and the virtual reception antenna b″₄ is virtually formed at the position spaced apart from where the virtual reception antenna b′₄ is formed by the transmission antenna group interval Dg (=D).

Considering the formation of the virtual reception antennas as described above, the interval between every adjacent two antennas on the reception end Dr′ corresponds to D.

Signal transmission and reception according to the entire antenna structure of FIG. 5 are as follows.

A Tx₁ signal is transmitted through the transmission antenna group G₁, a Tx₂ signal is transmitted through the transmission antenna group G₂, and a Tx₃ signal is transmitted through the transmission antenna group G₃.

The four real reception antennas B₁, B₂, B₃, and B₄ actually receive Rx₁, Rx₂, Rx₃, and Rx₄ signals, respectively.

It may be considered that, among the virtual reception antennas which are virtually formed, the four virtual reception antennas b′₁, b′₂, b′₃, and b′₄ respectively receive rx′₁, rx′₂, rx′₃, and rx′₄ signals which are the virtual signals which are virtually generated by a signal processing method with reference to the actually received signals.

It may be considered that, among the virtual reception antennas which are virtually formed, the remaining four virtual reception antennas b″₁, b″₂, b″₃, and b″₄ respectively receive rx″₁, rx″₂, rx″₃, and rx″₄ signals which are virtual signals virtually generated by a signal processing method with reference to the actually received signals.

The signals (Rx₁, Rx₂, Rx₃, and Rx₄ signals) actually received through the four real reception antennas B₁, B₂, B₃, and B₄ are real signals which are received when the Tx₁ signal is reflected. In addition, the virtual signals (rx′₁, rx′₂, rx′₃, and rx′₄ signals) which may be considered as being virtually received through the four virtual reception antennas b′₁, b′₂, b′₃, and b′₄, which are virtually formed, are virtual signals which are the same as those received when the Tx₂ signal is reflected, and the remaining virtual signals (rx″₁, rx″₂, rx″₃, and rx″₄ signals) which may be considered as being virtually received through the remaining four virtual reception antennas b″₁, b″₂, b″₃, and b″₄ which are virtually formed are the virtual signals which are the same as those received when the Tx₃ signal is reflected.

Meanwhile, referring to FIG. 5, virtual reception antennas (b′₄, b″₄ in FIG. 5) may not be virtually formed outside the outermost reception antenna B₁ or B₄ among the four real reception antennas B₁, B₂, B₃, and B₄, or corresponding signals (rx′₄ and rx″₄rx₅ in FIG. 5) may not be used even if the virtual reception antennas are virtually formed in order to reduce a calculated amount or the like.

The entire antenna structure exemplified in FIG. 5 may be summarized using related factors as Table 3.

TABLE 3

| | | |
|---|---|---|
| Transmission | Nt (Total Number of Transmission | 5 |
| Antenna | Antennas) | |
| Structure | n (Size of Transmission Antenna | 3 |
| | Group) | |
| | Ng (Number of Transmission Antenna | 3 |
| | Groups) | |
| | Dg (Transmission Antenna Group | D |
| | Interval) | |
| Reception | Nr (Total Number of Reception | 4 |
| Antenna | Antennas) | |
| Structure | Dr (Reception Antenna Interval) | 3D |
| | Nv (Number of Virtual Reception | 8 or 6 |
| | Antennas) | |
| | Dr′ (Reception End Antenna | D |
| | Interval) | |

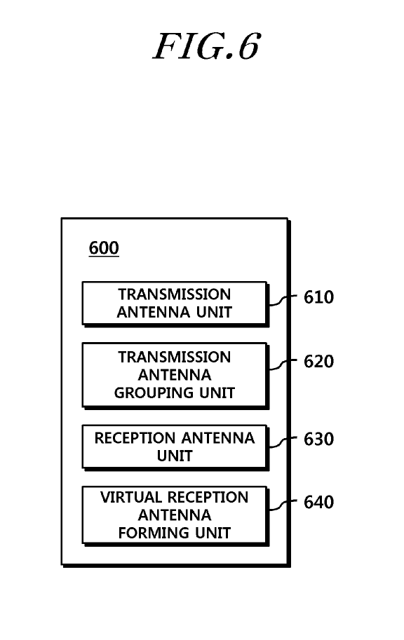

FIG. 6 is a block diagram of an antenna apparatus 600 according to an exemplary embodiment of the present invention.

Referring to FIG. 6, the antenna apparatus 600 according to an exemplary embodiment of the present invention includes: a transmission antenna unit 610 including a plurality of transmission antennas; a transmission antenna grouping unit 620 configured to group the plurality of transmission antennas by a predetermined number of transmission antenna groups such that the transmission antenna groups by the predetermined number of transmission antenna groups are formed and arranged at a transmission antenna group interval; and a reception antenna unit 630 including a plurality of reception antennas which are arranged at a reception antenna interval determined based on the number of transmission antenna groups and the transmission antenna group interval.

The number of transmission antenna groups may be determined based on the total number of transmission antennas and the size of a transmission antenna group.

The reception antenna interval may have a value obtained by multiplying the number of transmission antenna groups and the transmission antenna group interval.

Referring to FIG. 6, the antenna apparatus 600 according to the exemplary embodiment of the present invention may further include a virtual reception antenna forming unit 640 configured to perform a control such that virtual reception antennas are virtually formed at the position where the plurality of reception antennas are not placed.

The virtual reception antenna forming unit 640 may perform a control such that the virtual reception antennas are virtually formed at the positions where the plurality of reception antennas are not placed by performing signal processing that generates virtual signals having a phase difference which may be determined according to the transmission antenna group interval with reference to signals received through the plurality of reception antennas.

The virtual reception antenna forming unit 640 may perform a control such that a same number (Ng−1) of virtual reception antennas are virtually formed between every adjacent two reception antennas.

The virtual reception antenna forming unit 640 may perform a control such that virtual reception antennas are formed by the number of reception antennas determined according to the number of transmission antenna groups and the number of reception antennas.

The virtual reception antenna forming unit 640 may perform a control such that virtual reception antennas are formed only inside the outermost reception antennas among the plurality of reception antennas.

The antenna structure of the antenna apparatus 600 is the same as the antenna structure described above with reference to FIGS. 1 to 5.

An object of the radar apparatus 100 and the antenna apparatus 600 according to the exemplary embodiments of the present invention is to enhance resolution. Here, the resolution is also referred to as discrimination (resolving power) which means a performance of precisely discriminating two adjacent objects. This is one of very important performance factors of the radar apparatus 100 and the antenna apparatus 600.

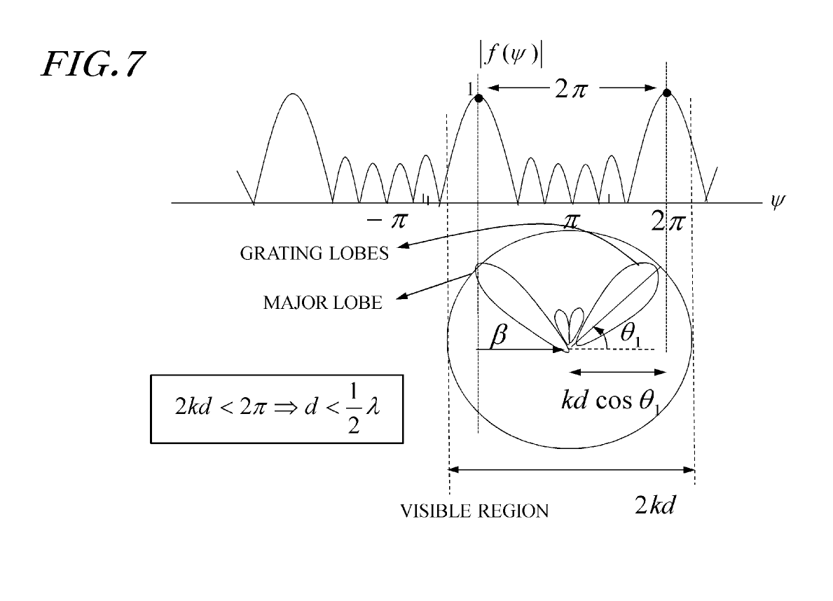

In addition, another object of the radar apparatus 100 and the antenna apparatus 600 according to the exemplary embodiment of the present invention is to avoid a grating lobe, which is also one of very important performance factors of the radar apparatus 100 and the antenna apparatus 600. Grating lobe occurrence and avoidance conditions will be described with reference to FIG. 7.

FIG. 7 is a view for describing a principle for avoiding a grating lobe phenomenon in the radar apparatus 100 and the antenna apparatus 600 according to the exemplary embodiments of the present invention.

Referring to FIG. 7, when a circle having a radius kd is projected to Ψ, a grating lobe phenomenon may occur if one or more peaks existing on a universal pattern belongs to this range.

At this time, the grating lobe exists to have the same size as a main beam.

In order to avoid such a grating lobe, the following Equation 5 shall be satisfied.

2kd<2π [symbol] d<½λ

In Equation 5, kd refers to a projection (transmission) radius of a signal, d is an antenna interval, and λ is a wavelength of the signal.

According to Equation 5, in order to avoid the grating lobe, the antenna interval d should be smaller than a half wavelength λ/2 of the signal.

However, when the antenna interval d is too small, the resolution (resolving power) is lowered.

Accordingly, considering avoidance of a grating lobe and high resolution, the antenna interval d should be smaller than a half wavelength λ/2 of the signal and larger than a critical value (critical value of the antenna interval) which does not excessively degrade the resolution.

As described above, in order to meet with a condition of an antenna interval d for achieving avoidance of a grating lobe and high resolution, the radar apparatus 100 and the antenna apparatus 600 according to the exemplary embodiments of the present invention form virtual reception antennas at proper positions and at a proper interval such that a reception end antenna interval Dr′ becomes larger than the critical value (the critical value of the antenna interval) which does not excessively degrade the resolution and smaller than a half wavelength λ/2 of a signal, and have an antenna structure suitable therefor.

That is, according to the present invention described above, it is possible to provide a radar apparatus and an antenna apparatus which include an antenna structure capable of suppressing a grating lobe while enhancing resolution.

In addition, according to the present invention, it is possible to provide a radar apparatus and an antenna apparatus which are provided with an antenna grouping structure which is designed by arranging transmission antennas having a smaller beam width and tying a plurality of transmission antennas together so as to reduce signal reception in an inclined area other than an interested front area and the influence of a grating lobe.

In this case, the resolution may be further enhanced when the interval of the virtual array antennas is made to be equal to or larger than a half wavelength while making the reception antenna interval suppress the influence of a grating lobe.

What is claimed is:

1. A radar apparatus comprising:
a transmission antenna unit including a plurality of transmission antennas;
a transmission antenna grouping unit configured to group the plurality of transmission antennas by a predetermined number of transmission antenna groups such that the transmission antenna groups by the predetermined number of transmission antenna groups are arranged and formed at a predetermined transmission antenna group interval;
a reception antenna unit including a plurality of reception antennas arranged at a reception antenna interval which is determined based on the number of transmission antenna groups and the transmission antenna group interval;
a signal transmission/reception unit configured to transmit a signal through the transmission antenna groups by the number of the transmission antenna groups and receive a signal when the transmitted signal is reflected through the plurality of reception antennas; and
an object sensing unit configured to sense an object based on the received signal.

2. The radar apparatus of claim 1, wherein the transmission antenna grouping unit causes at least one of the plurality of transmission antennas to be commonly included in two or more transmission antenna groups.

3. The radar apparatus of claim 1, wherein the number of the transmission antenna groups is determined based on the total number of transmission antennas and the size of a transmission antenna group.

4. The radar apparatus of claim 1, further comprising:
a virtual reception antenna forming unit configured to perform a control such that virtual reception antennas are virtually formed at positions where the plurality of reception antennas are not placed.

5. The radar apparatus of claim 4, wherein the virtual reception antenna forming unit performs a control such that a same number of virtual reception antennas are virtually formed between every two adjacent reception antennas.

6. The radar apparatus of claim 4, wherein the virtual reception antenna forming unit performs a control such that the virtual reception antennas are virtually formed at a position where the plurality of reception antennas are not placed by performing signal processing which generates a virtual signal having a phase difference which may be determined according to the transmission antenna group interval with reference to the signal received through the plurality of reception antennas.

7. The radar apparatus of claim 6, wherein the object sensing unit senses the object based on the received signal and the generated virtual signal.

8. The radar apparatus of claim 7, wherein the object sensing unit detects a distance to the object, a velocity of the object, and a bearing of the object based on a synthesized signal which is obtained by compensating for a phase difference between signals for the received signal and the generated virtual signal and synthesizing the signals for which the phase difference has been compensated for.

9. The radar apparatus of claim 6, the virtual reception antenna forming unit does not generate a virtual signal outside an outermost reception antenna among the plurality of reception antennas.

10. An antenna apparatus comprising:
a transmission antenna unit including a plurality of transmission antennas;
a transmission antenna grouping unit configured to group the plurality of transmission antennas by a predetermined number of transmission antenna groups such that the transmission antenna groups by the predetermined number of transmission antenna groups are arranged and formed at a predetermined transmission antenna group interval; and
a reception antenna unit including a plurality of reception antennas arranged at a reception antenna interval which is determined based on the number of transmission antenna groups and the transmission antenna group interval.

11. The antenna apparatus of claim 10, wherein the number of transmission antenna groups is determined based on the total number of transmission antennas and a size of a transmission antenna group.

12. The antenna apparatus of claim 10, further comprising:
a virtual reception antenna forming unit configured to perform a control such that virtual reception antennas are virtually formed at positions where the plurality of reception antennas are not placed.

13. The antenna apparatus of claim 12, wherein the virtual reception antenna forming unit performs a control such that the virtual reception antennas are virtually formed at position where the plurality of reception antennas are not placed by performing signal processing which generates a virtual signal having a phase difference as compared with a signal received through the plurality of reception antennas, based on an antenna interval on a reception end including the plurality of reception antennas and virtual reception antennas.
